(19) United States
(12) Patent Application Publication
(10) Pub. No.: US 2013/0057519 A1
(43) Pub. Date: Mar. 7, 2013

(54) DISPLAY REFRESH SYSTEM

(71) Applicants: Louis Joseph Kerofsky, Camas, WA (US); Sachin G. Deshpande, Camas, WA (US)

(72) Inventors: Louis Joseph Kerofsky, Camas, WA (US); Sachin G. Deshpande, Camas, WA (US)

(73) Assignee: SHARP LABORATORIES OF AMERICA, INC., Camas, WA (US)

(21) Appl. No.: 13/224,273

(22) Filed: Sep. 1, 2011

(51) Int. Cl. G09G 5/00

(52) U.S. Cl. 345/204

(57) ABSTRACT

A display refresh system for video includes a refresh process that selects between two processes. A first process refreshes the entire display with a frame of the video based upon a change between frames of the video which is not based on explicit image motion. A second process refreshes a selected subset of the display based upon pixels of the display that have changed.

### CROSS-REFERENCE TO RELATED APPLICATIONS

None.

### BACKGROUND OF THE INVENTION

The present invention relates generally a display refresh system.

As a result of an ever increasing environmental awareness together with ever increasing expenses for power it is desirable to reduce the power requirements of a display. In addition, for mobile devices having a display with limited available battery power it is desirable to reduce the power requirements of the display. Reducing the power requirements for mobile devices increases the duration that the battery can provide power to the display.

One technique to reduce the power requirements of a display device is to dim the backlight for the entire display. While this provides one mechanism for reducing the power requirements of the display, it results in a dim display that is not especially desirable. A modified technique is to reduce the power used by the backlight while simultaneously increasing the transmission of a liquid crystal layer so that, in general, the overall brightness of the display is preserved. While such a technique reduces the power usage of the display, it limits image highlights.

What is desired therefore is a technique for reducing the power consumption of a display without substantially impeding its display quality.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a first image on a display.

FIG. 2 illustrates a second image on a display.

FIG. 3 illustrates the lines that changed between the first and second images.

FIG. 4 illustrates a selective line refresh system.

FIG. 5 illustrates a selective line refresh system with color to monochrome conversion.

FIG. 6 illustrates a frame refresh system.

FIG. 7 illustrates different levels of estimated motion.

FIG. 8 illustrates a frame rate selection mechanism.

FIG. 9 illustrates a frame modification technique.

FIG. 10 illustrate a combined line and frame refresh technique.

### DETAILED DESCRIPTION OF PREFERRED EMBODIMENT

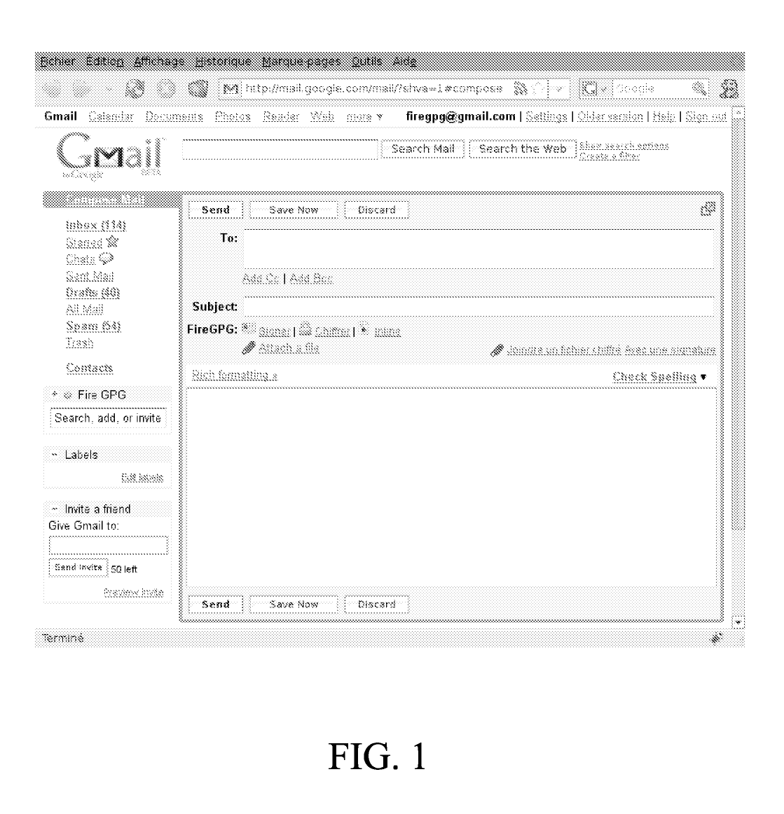

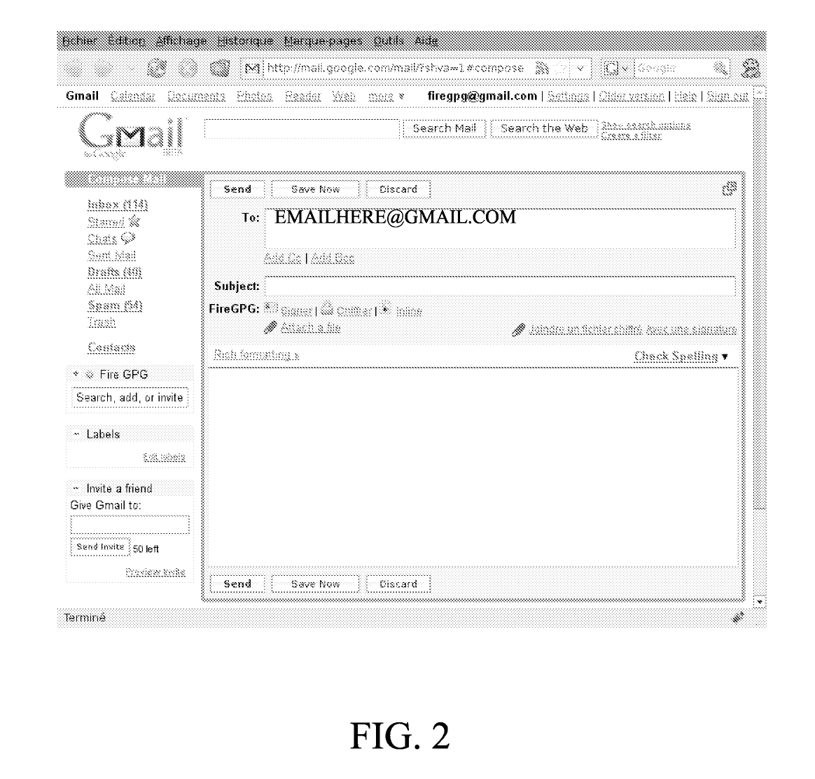

Referring to FIG. 1 and FIG. 2, in many mobile display applications the display does not tend to significantly change between a sequential set of frames. As illustrated in FIG. 1 and FIG. 2, the difference between the frames is the addition of an e-mail address in FIG. 2, with the remainder of the display remaining unchanged. Similar limited changes in the display over a sequence of frames occurs when receiving and/or sending text messages on a mobile device.

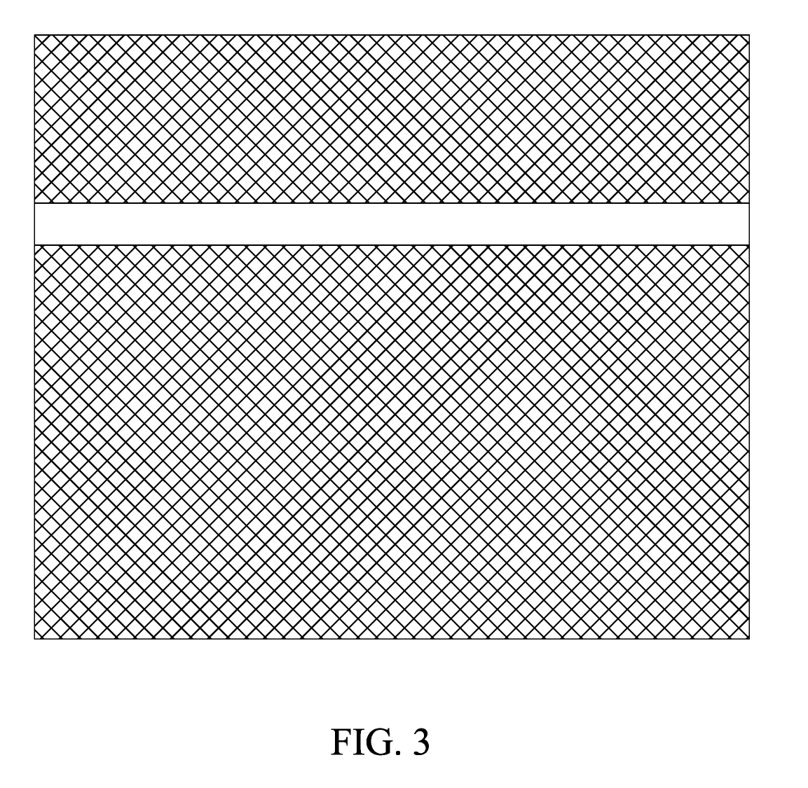

In many display technologies, such as liquid crystal displays, the display includes a series of row drivers which provide a signal across the display, or a portion thereof. In combination with the row drivers, the display may include column drivers which provide a signal down the display, or a portion thereof. As a result of the combination of the horizontal signal drivers and the vertical signal drivers, selected pixels of the display may be selected during a frame to change their state (e.g., intensity). Referring to FIG. 3, the changed pixels (or having a sufficient change) between the FIG. 1 and FIG. 2, includes a series of rows of the display. It is these rows of the display which should be updated between FIG. 1 and FIG. 2 to reflect the changes that have occurred.

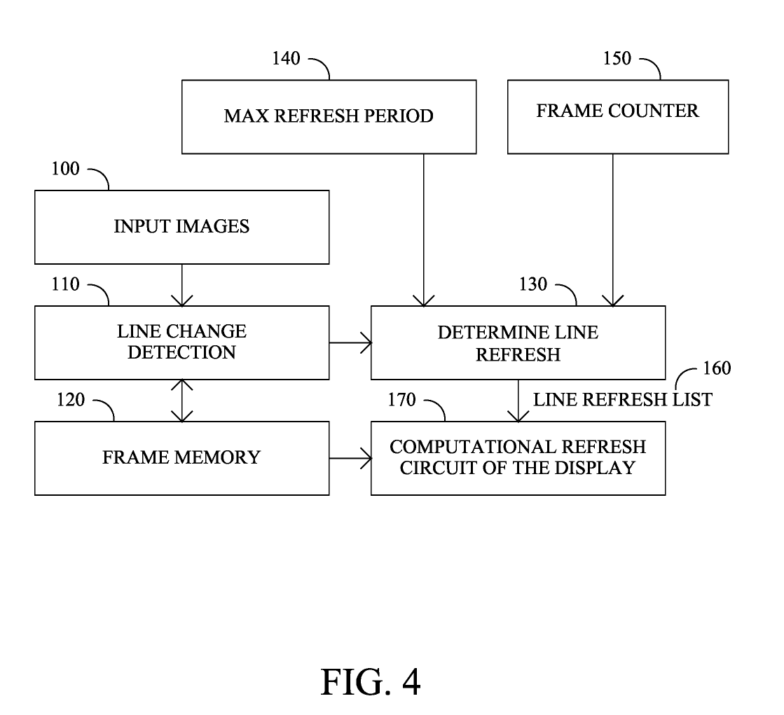

Referring to FIG. 4, a system suitable for selectively updating the display in a power efficient manner is illustrated. A series of input images 100 for rendering on the display are received. A line change detection 110 compares the received input image 100 against a previous input image stored in a frame memory 120. Sufficient changes between the input image 100 and the frame stored in the frame memory 120 is determined and the rows of the display corresponding with such changes are identified. The sufficient change may be based upon one or more pixels having a change, and/or one or more pixels having a change greater than a threshold. After identifying the changes, the frame stored in the frame memory 120 may be updated with the received input image 100 and/or particular lines of the input image 100 and/or particular pixels of the input image 100. The lines that should be updated as a result of the comparison are provided to a determine line refresh 130.

For many displays, there is a limited duration that a pixel will effectively retain its state without being refreshed. This time period, or a time period somewhat less, may be selected as a maximum refresh period 140. A frame counter 150 (or other timing mechanism) may be used to determine when particular lines that are not otherwise refreshed as a result of the line change detection 110, should be selected by the determine line refresh 130 to be refreshed. For example, for a display with a refresh rate of 60 hertz and a stable pixel time of 1 minute, the maximum refresh period may be 360 (frames). The determine line refresh 130 thus determines a collective line refresh list 160.

Artifacts in the display may result if selected sets of lines are repeatedly simultaneously refreshed over a period of time. To reduce the artifacts, the determine line refresh 130 may refresh every P^{th} line of a frame during each frame count, or any other suitable manner of line selection. Another technique that may be to used is to update the entire frame on a regular basis. Another technique may be to base the update of unchanged lines on the time since the last update.

A conditional refresh circuit of the display 170 refreshes the selected rows of the display based upon the line refresh list 160 and the frame stored in the frame memory 120. In this manner, the power usage of the display may be significantly reduced while maintaining image quality.

The conditional refresh circuit of the display 170 may selectively write only the selected lines from the frame buffer to the display. To further reduce the power consumption, the refresh circuit 170 may power down the amplifier(s) associated with a particular row of the display when the amplifier is not needed to write data to the display or otherwise power down the amplifier(s) associated with the display when not needed to write data to the display.

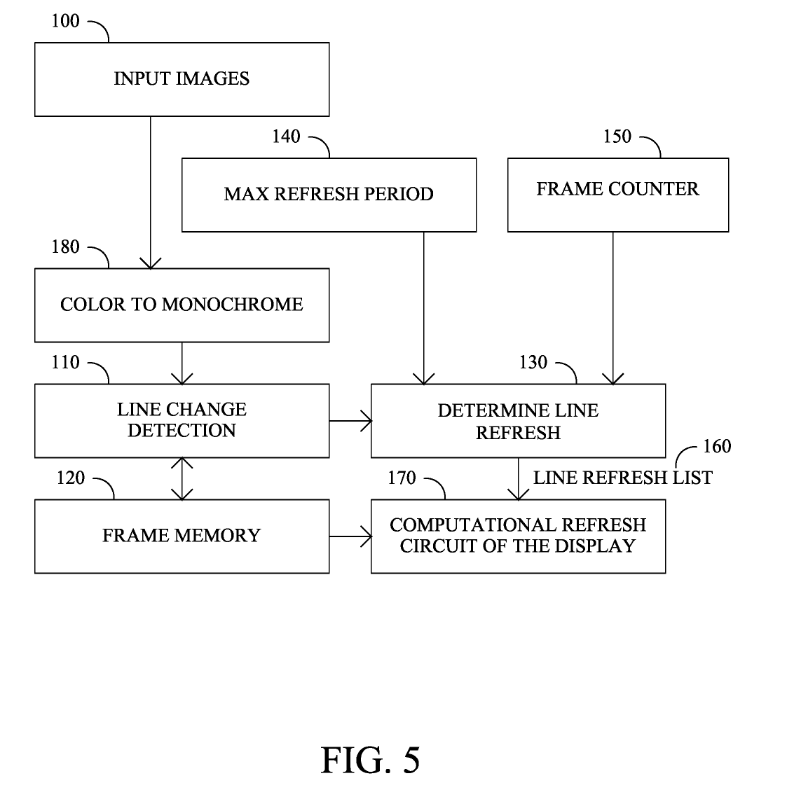

Referring to FIG. 5, in some cases the input image 100 is converted from a color image to a monochrome image 180, which further reduces the power usage. In many cases, for a color sequential display the frame rate addressing is three times or more than the display frame rate. By a color to monochrome conversion, the frame rate may be substantially reduced. In the case of a monochrome display, such as an e-book reader, this is a desirable capability.

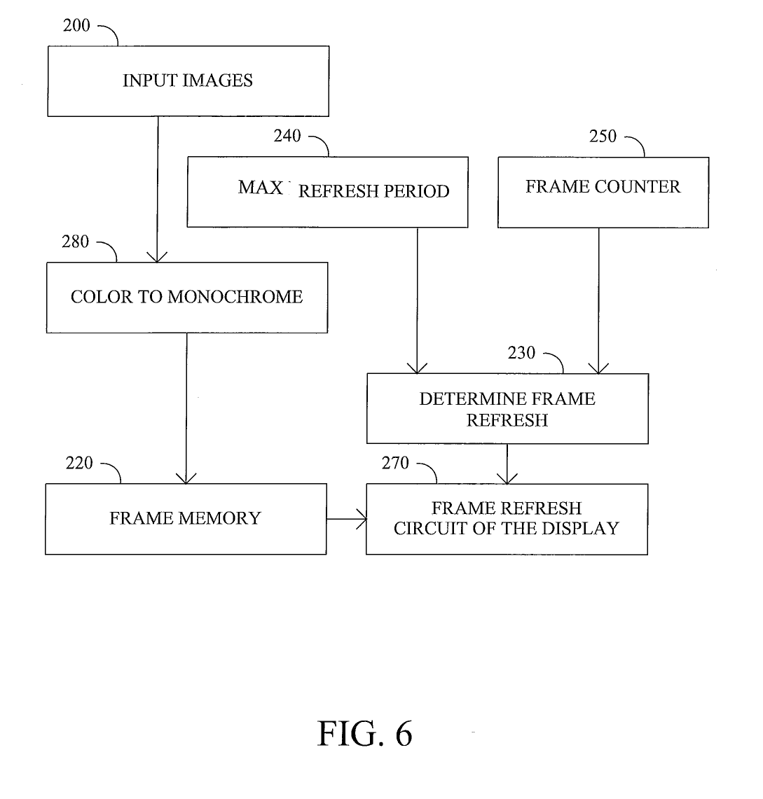

In some cases, it is desirable to refresh the entire display rather than selecting particular lines of the display (e.g., less than all available lines) to refresh. This occurs when a significant number of lines have changed or otherwise the system is presenting video content to the viewer. This also occurs when system hardware may support frame level refresh control only and not finer control such as line level due to cost for instance. Referring to FIG. 6, a system suitable for updating the entire display in a power efficient manner is illustrated. A series of input images 200 for rendering on the display are received. In some cases the input image 200 is converted from a color image to a monochrome image 280, which further reduces the power usage. The input image 200 is stored in a frame memory 220.

For many displays, there is a limited duration that a frame of pixels will effectively retain its state and/or a limited duration between which a frame should be updated depending on its particular content. This time period, or a time period somewhat less, may be selected as a maximum refresh period 240. A frame counter 250 (or other timing mechanism) may be used to determine when a frame that is not otherwise refreshed should be refreshed. A determine frame refresh 230 receives the maximum refresh period 240 and the frame counter 250 information to determine when the frame should be updated. When the determine frame refresh 230 determines a frame should be updated, a signal is provided to a frame refresh circuit of the display 270 that uses the current data from the frame memory 220 to refresh the display with the current frame. Accordingly, the determine frame refresh 230 may omit some of the received frames, and thus reduce the power requirements.

The selection among a set of potential video frame rates may be based upon the content of the video itself. For example, when the video content has a high motion a high frame rate may be used. For example, when the video content has low motion a low frame rate may be used. For example, when the video content has moderate motion a medium frame rate may be used. To maintain relatively lower power usage, the motion estimation process should be computationally efficient. The motion estimation process should not include expressly determining the motion of groups of pixels between one frame and another, since motion estimation tends to be computationally complex. Rather than an explicit motion estimation of groups of pixels between frames, the system preferably compares a pair of frames and determines if a sufficient change has occurred. While such a determination does not directly determine if substantial motion has occurred, it does provide some indication of whether such motion is likely. Moreover, the computation between only a pair of frames may be performed using a single frame buffer together with one or more line buffers (less than a frame buffer), which is computationally efficient.

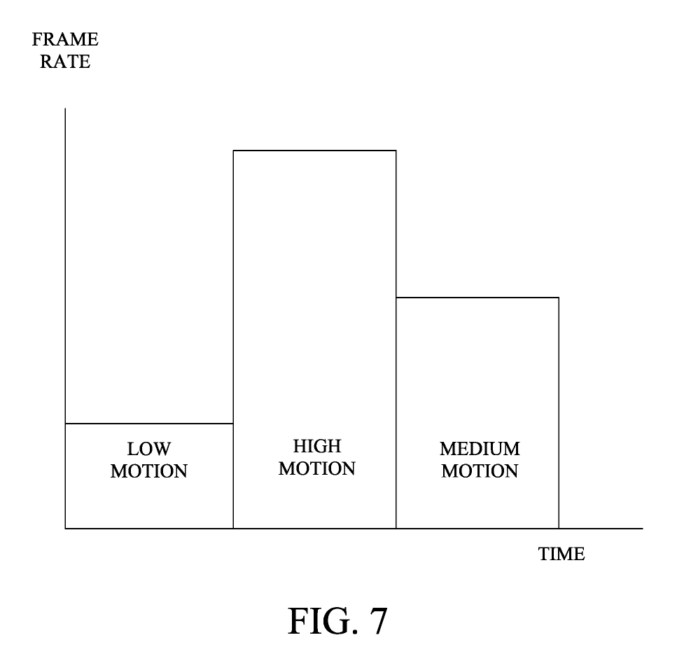

Referring to FIG. 7, a video sequence may be quantized by the system as a plurality of different motions levels, such as low motion, medium motion, and high motion. Based upon one of these motion levels, the system may adapt the refresh rate of the video content being display accordingly. For example, when the video content has a high motion a high frame rate may be used. For example, when the video content has low motion a low frame rate may be used. For example, when the video content has moderate motion a medium frame rate may be used. Additional quantized levels could be utilized by further classifying motion levels.

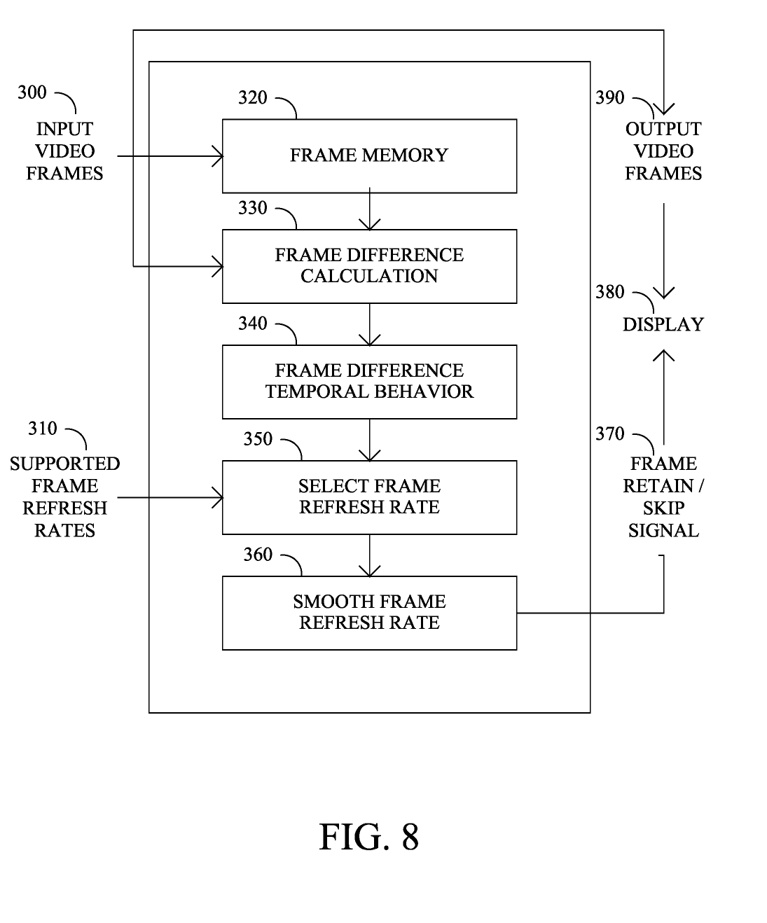

Referring to FIG. 8, one exemplary technique to estimate the difference between frames, together with selecting an appropriate frame rate is illustrated. The system may receives a series of input video frames 300. In some embodiments the frame rate of the input video frames 300 may correspond with the video source frame rate, such as 15 frames per second, 24 frames per second, 30 frames per second, 60 frames per second, 120 frames per second, and/or 240 frames per second. For example, the frames may be progressive and/or interlaced. The display typically supports a set of frame rates 310, such as 15 frames per second, 30 frames per second, 60 frames per second, 120 frames per second, and/or 240 frames per second. In this manner, the system should perform the frame rate selection to match the input frame rate to the available display frame rates.

The frame rate selection may use a frame memory 320 (or another frame memory) to store the previously received frame. A frame difference calculation 330 may compute the difference between the incoming frame(i) and the previous frame(i−1) on a pixel by pixel basis. The incoming frame data may arrive in a line by line manner. The difference may be determined on the basis of absolute differences. Other techniques to compute a change between frames may likewise be used. A frame difference temporal behavior 340 determines the temporal behavior of the frame difference to determine the general trends. In this manner, the system may react to the changes in the differences (generally indicating the existence of motion) without tending to oscillate back and forth between different frame rates. For example, a moving average of the previous N values of the sum of absolute frame differences may be calculated and used as the basis to select a frame rate for the display.

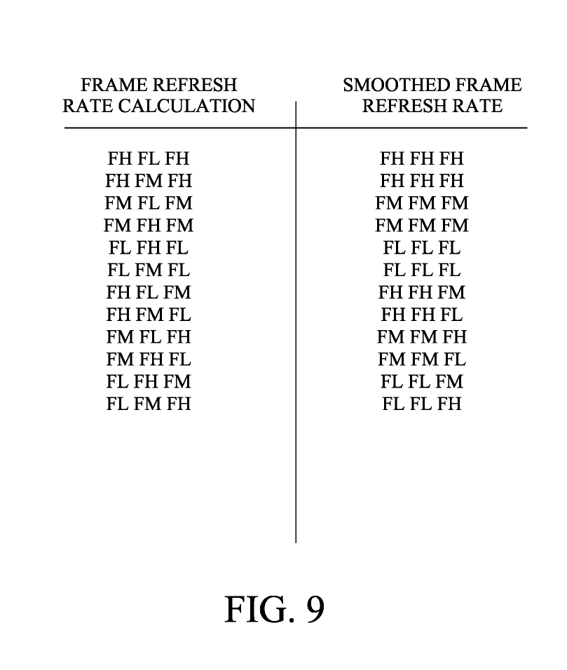

A select frame refresh rate 350 may compute a suitable frame refresh rate for the current input video frames 300, on a per frame basis. By way of example, the frame refresh rate may be determined by comparing the sum of absolute frame differences with an upper and a lower threshold and also comparing it with a moving average. A smooth frame refresh rate 360 may be used to inhibit frequent fluctuations in the frame refresh rate. For example, the system may support three refresh rates, frame high (FH), frame medium (FM), and frame low (FL), that may be selected based upon a set of sequential frames. Referring to FIG. 9 for example, the selected frame rate may be modified to modify selected frame rate change patterns. In this case, all rate changes at a single frame may be removed.

A frame retain/skip signal 370 may be provided that indicates whether a particular frame should be displayed or otherwise skipped when being rendered on the display 380 from a set of output video frames 390. For example, when the current frame difference is below moving average frame difference and/or the current frame difference is below a low threshold, a low frame rate may be used. When the current frame difference is above moving average frame difference and/or the current frame difference is above a high threshold, a high frame rate may be used. When the moving average frame difference and/or the current frame difference is at an intermediate value (below a high threshold and above a low threshold), a medium frame rate may be used. In addition, the selected frame rate may be modified based upon temporal characteristics of the video content.

In many cases, reduced power savings while maintaining sufficient display quality may be achieved by selecting an appropriate technique between refreshing the entire display and refreshing selected lines of the display. For relatively still images a frame adaptive refresh control technique (selectively updating rows of the display) may be used to reduce the refresh rate and increase the responsiveness of the system. For relatively high motion based video, motion adaptive refresh control (selectively refreshing the entire display) may be used to lower the refresh rate while maintaining display quality.

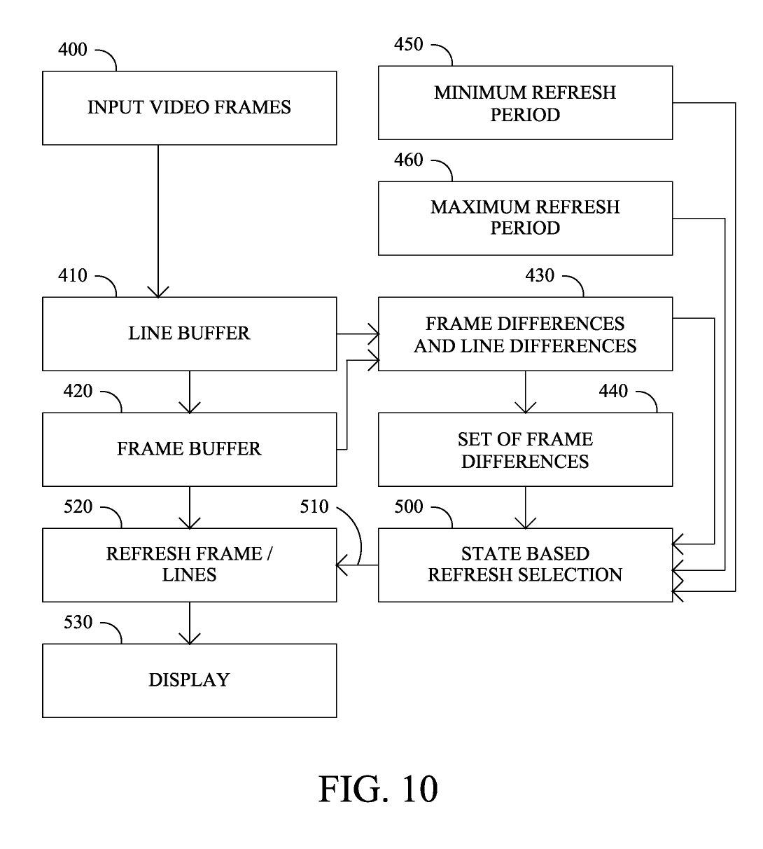

Referring to FIG. 10, the system may receive a set of input video frames 400 which are received by a line buffer 410, and a previous frame being stored in a frame buffer 420. A frame differences and line differences module 430 may determine the differences between the current input video frame 400 as it is received in the line buffer and the previous input video frame 400 stored in the frame buffer 420. The frame differences and line differences module 430 may also determine the differences in each of the lines to identify those lines that have a sufficient difference such that the line should be updated. In this manner, the system may track both the line based differences and the frame based differences.

A set of frame differences 430 may be tracked as a temporal set of frame differences 440. The temporal set of frame differences 440 together with a minimum refresh period 450 may be used to determine an appropriate frame refresh rate by a state based refresh selection 500. The line differences 430 together with a maximum refresh period 460 may be used to determine appropriate lines to be refreshed by the state based refresh selection 500. The state based refresh selection 500 determines whether a frame based technique or a selected line based technique should be used for refreshing the display. In the case of a frame based technique, the state based refresh selection provides a signal 510 indicating whether a particular frame should be refreshed 520 or otherwise at what rate the frames should be refreshed. In the case of a line based technique, the state based refresh selection provides a signal 510 indicating which lines of the frame should be refreshed 520. The refresh frames/lines 520 provide a signal to the display 530 for updating the frame/lines of the display.

One technique for adapting between the “still” and “video” states is to track the amount of changes between frames and/or lines of frames over time. If the recent frames have a sufficient non-zero difference and/or a sufficient number of lines tend to change on a per frame basis, then the “video” state should be used. If the recent frames have a sufficiently small difference and/or a minimal number of lines tend to change on a per frame basis, then the “still” state should be used. As a general matter, depending on the type of display, the row and column drivers may have a different architecture. In addition, the technique may include using selective rows for part of the display and a frame based technique for part of the display. In this manner, the system may be adaptive for displays that include video content in only a portion of the display. Further, the techniques may be applied to other display technologies, such as organic light emitting diode displays, plasma displays, and/or electroluminescent displays.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A display refresh system for video comprising:
(a) a refresh process that selects between
a first process that refreshes the entire said display with a frame of said video based upon a change between frames of said video which is not based on explicit image motion; and
(ii) a second process that refreshes a selected subset of said display based upon pixels of said display that have changed.

2. The system of claim 1 wherein said second process refreshes selected rows of said display based upon said change.

3. The system of claim 2 wherein said selected rows is based upon a line change detection process.

4. The system of claim 3 wherein said line change detection process is based upon a previous frame stored in a frame memory.

5. The system of claim 4 wherein said selected rows is also based upon a maximum refresh period.

6. The system of claim 5 wherein said selected rows is also based upon a frame counter.

7. The system of claim 4 wherein said selected rows further includes a selected set of additional rows that are not based upon said change.

8. The system of claim 1 further including converting said video from a set of color frames to a set of monochrome frames.

9. The system of claim 1 wherein said first process refreshes said entire display at one of a plurality of predetermined refresh rates.

10. The system of claim 9 wherein said first process refreshes said entire display within a predetermined refresh time period.

11. The system of claim 10 wherein said first process refreshes said entire display after omitting at least one received frame.

12. The system of claim 11 wherein said first process includes a temporal based smoothing process.
